(19) United States
(12) Patent Application Publication
(10) Pub. No.: US 2004/0122847 A1
(43) Pub. Date: Jun. 24, 2004

(54) Method and software for precluding unsolicited email messages

(76) Inventor: John B. Rodgers, Winnetka, IL (US)

Correspondence Address: King & Jovanovic, PLC, 170 College Avenue, SUITE 230, HOLLAND, MI, 49423, US

(21) Appl. No.: 10/324,909

(22) Filed: Dec. 20, 2002

(51) Int. Cl. G06F 17/00

(52) U.S. Cl. 707/102

(57) ABSTRACT

A method and associated computer software product for minimizing the receipt of unsolicited email messages. The method comprises the steps of receiving an email message from a sender, identifying the email message as comprising an unsolicited email message, and generating at least one reply email message, wherein the reply email message comprises a “bounce back” email message, to, in turn, facilitate an identification of the email address to which the unsolicited email was sent as being an invalid email address.

### BACKGROUND OF THE INVENTION

1. Field of the Invention

The present invention relates in general to email systems, and more particularly to a method and associated software for precluding and minimizing unsolicited email messages.

2. Background Art

As the use of email increases, and as the costs associated with internet service providers decreases, the use of email as a means for advertising is becoming increasingly widespread. It is not uncommon for an individual to receive ten to fifteen unsolicited advertisements via an email message for every one useful or desired email message. In addition, as the transmission of unsolicited email messages increases, the use of more sophisticated methods (such as the purchasing of valid emails, etc.) becomes more prevalent.

Certain software systems have been developed to minimize the receipt of unsolicited email messages. For example, certain email programs (i.e., Microsoft Outlook) include filters which can be set by the user so that what has been identified by the user as “junk” email is automatically moved to the deleted items folder upon receipt. Other programs utilize similar filters at, for example, remote servers, to filter email prior to retransmission to the end user. While these systems have alleviated some of the irritation and discomfort relative to unsolicited email, these systems generally only react to the current and sent email messages and do not minimize the transmission of future unsolicited email messages.

Accordingly, it is an object of the present invention to provide a system and software that minimizes the transmission of unsolicited email.

This object, as well as other objects shall become apparent in light of the specification and claims attached hereto.

### SUMMARY OF THE INVENTION

The invention comprises a computer program product for minimizing the receipt of unsolicited email messages. The computer program product comprises a computer data storage device and computer program instructions. The computer program instructions are recorded on the computer data storage device and are executable by a computer processor. The computer program instructions are capable of performing the steps of: receiving an email message from a sender; identifying the email message as comprising an unsolicited email message; and generating at least one reply email message, wherein the reply email message comprises a “bounce back” email message, to, in turn, facilitate an identification of the email address to which the unsolicited email was sent as being an invalid email address.

In a preferred embodiment, the step of identifying comprises the step of requiring manual user identification of the email message as comprising an unsolicited email message. Preferably, the step of requiring further comprises the step of adding the sender to a database of senders of unsolicited email messages. In one embodiment, the step of requiring further comprises the step of requiring user manual identification only if the sender is not one of the senders of unsolicited email messages identified in the database of senders of unsolicited email messages.

In one embodiment of the invention, the step of identifying comprises the steps of: comparing the sender of the email message with a database of senders of unsolicited email; and determining if the sender of the email message corresponds to one of the senders on the database of senders of unsolicited email.

In one such embodiment, the database used in the step of comparing is maintained at a second computing device.

In one embodiment, the step of generating comprises the step of generating a plurality of “bounce back” email messages. Preferably, the computer program instruction comprises a plug-in to an email receiving software product.

### BRIEF DESCRIPTION OF THE DRAWINGS

The invention will now be described with reference to the drawings wherein:

FIG. 1 of the drawings is a schematic representation of a network of computers.

### DETAILED DESCRIPTION OF THE INVENTION

While this invention is susceptible of embodiment in many different forms, there is shown in the drawings and will be described in detail, a specific embodiment with the understanding that the present disclosure is to be considered as an exemplification of the principles of the invention and is not intended to limit the invention to the embodiment illustrated.

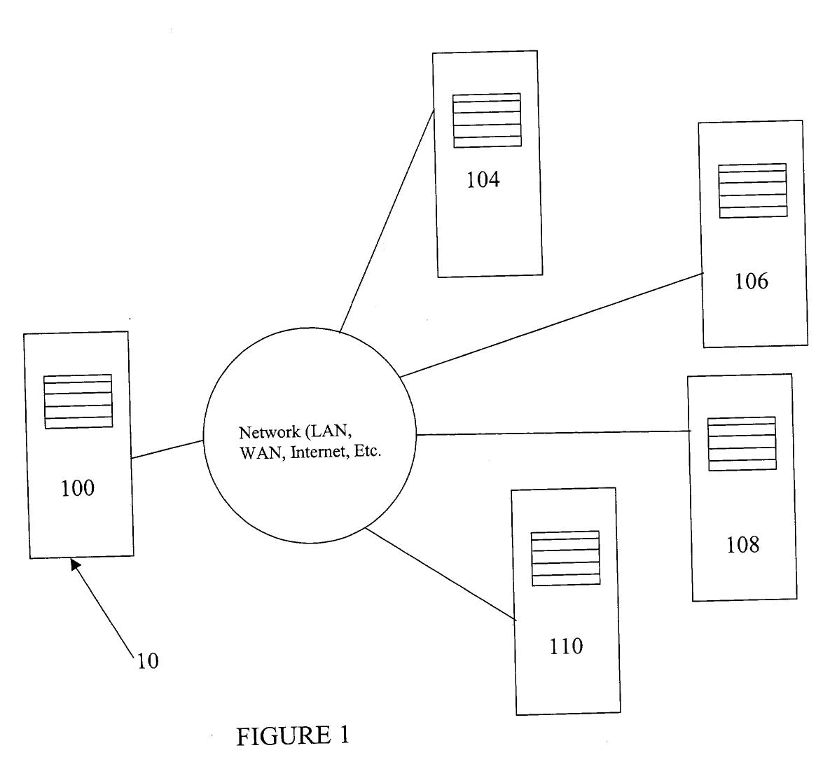

Referring now to the drawings, and to FIG. 1 in particular, software 10 which is used to implement the method is shown as being associated with computer 100. Computer 100 may comprise any number of different systems (i.e., PC, PPC, Mac, Palm, etc.) incorporating a variety of different operating systems (i.e., MS Windows 98, 2000, XP, Mac OS 9, X, Palm OS, PPC, Linux etc.). Each such computer generally includes a computer data storage device (i.e., internal memory, external memory, hard drive, CD-ROM, etc), a processor, and, input and output devices. Software 10 may be a standalone software package, or may be a plug-in that is incorporated within other existing software on computer 100 (i.e., a plug-in for MS Outlook, Eudora, Entourage, etc.).

Computer 100 is connected to an outside mail server 104 through various different connections (i.e., dial-up, DSL, T1, T3, WLAN, LAN, etc.) either directly, or through a number of intermediate servers and computers. Computer 100 is likewise connected to email compiling server 106, unsolicited email generating and sending server 108 and valid email address maintaining server 110. Again, computer 100 may be connected directly to such other servers, or may be connected through any number of intermediate servers and computers.

As will be explained, outside mail server 104 comprises a computer through which computer 100 receives email messages directed to a particular mail address. Email compiling server 106 compiles various lists of different addresses from which unsolicited email is generated and sent, as well as lists associated with different addresses which correspond to the sending address of unsolicited email. Unsolicited email generating and sending server 108 generates and sends unsolicited emails to email addresses which are compiled and maintained by valid email address maintaining server 110.

Without the use of the present invention, the general operation of the system is such that the valid email address maintaining server 110 generates, compiles and maintains a listing of valid email addresses. The operator of server 110 sells the generated lists of valid email addresses to the operators of unsolicited email server 108. In turn, unsolicited email server 108 generates email advertisements and sends the advertisements to each of the valid addresses which were provided by server 110. The messages are transmitted and received by the end user on his or her computer via an email retrieval program (i.e., Outlook, Outlook Express, Eudora, Netscape, Opera, etc.). The user is then faced with receiving and generally deleting the unsolicited email message.

From time to time, a message that was sent to what was presumed to be a valid email address is unable to reach the destination address for a variety of reasons (i.e, the address is invalid, the server no longer exists, etc.). In such an instance, a message is transmitted back to unsolicited email server 108 identifying that the unsolicited email message was unable to be sent to the desired recipient. This is commonly known as a message that has “bounced back.” It is not uncommon for a certain percentage of the messages sent by unsolicited email server 108 to “bounce back.” Generally, the server keeps track of the email addresses which “bounced back” so that the system does not send future messages to the apparently invalid email address. From time to time, server 108 and/or server 110 update “valid” email addresses by adding newly uncovered addresses, and by removing addresses which appear to be invalid (due to “bounce back” messages).

With the present system, the software maintained by computer 100 in cooperation with compiling server 106 provides a method of minimizing the receipt of unsolicited email. In particular, compiling server 106, through various different methods and techniques, develops and maintains a number of databases corresponding to servers and email addresses which are used to send unsolicited emails. One method of obtaining such information is to create a plurality of different addresses in an attempt to receive unsolicited email, and, to track the receipt of such unsolicited email relative to the sending server and sending address. Over time, lists can be compiled. Of course, other methods of building such databases are contemplated, and the invention is not limited to any particular type of system by which such lists are generated and maintained.

The software on computer 100 can connect to compiling server 106 so as to receive an identification of the different server addresses and email addresses from which suspected unsolicited email is sent. Armed with the unsolicited email originating addresses, the computer monitors email messages as they are received by computer 100. Upon receipt of an email from an address which corresponds to a suspected unsolicited email originating address, while the message was received, the software nevertheless generates at least one “bounce back” type message back to the sender from which the unsolicited email was received so that the sender believes the email address is not valid. The message may additionally deleted from computer 100.

As the “bounce back” message reaches unsolicited email generating server 108, the email generating server 108 identifies the “bounce back” message and identifies the email address in the “bounce back” message as being an “invalid” email message. As a result, email generating server 108 may remove the email address from the list of valid email addresses, and in turn, such an indication is eventually transmitted to server 110. As such, as a result of the “bounce back” message generated by computer 100 upon receipt of an unsolicited email (even though the message was, in fact, received), the email address is removed from the unsolicited email generating server and future unsolicited email generated by server 108 is not sent to the email address of the user of computer 100.

In one variation of the system, the software on computer 100 may compile its own database of suspected unsolicited email generating servers and corresponding addresses. The list may be compiled manually by a user. For example, the software may provide a radio button, or other indicator which the user “clicks” or activates upon receipt of an unsolicited email. Upon the activation of the indicator, the system generates a return “bounce back” message and further adds the sender from which the unsolicited email was sent to a real-time database. Such a manual addition is only required one time. After the addition to the database, future received emails are automatically handled by the software.

The foregoing variation may be used instead of the server 106 identified above, or may be used in conjunction with the remote server 106. Specifically, when used in conjunction with server 106, as the user identifies a “new” sender of unsolicited email and manually identifies the sender as a sender of unsolicited email, computer 100 can send a message to server 106 providing information to server 106 as to the sender for addition to the database of the sender.

In another variation of the system, the system may send a number of “bounce back” messages upon receipt of an unsolicited email message. Depending on the configuration of the unsolicited email servers 108, more than one “bounce back” message is required to be received as a result of a failed transmission of an unsolicited email prior to deletion of the email address from the listing of valid email addresses. To overcome such server variations, software 10 may be configured to respond to an unsolicited email with a plurality of “bounce back” messages.

In yet another variation of the system, software 10 may be augmented or replaced with similar software located on the mail server itself. As such, the mail server may respond to what are perceived to be unsolicited email messages at the mail server level, instead of first transmitting the message to computer 100 and providing a response from computer 100. Such a variation may minimize email traffic associated with the particular mail server, and operation at the server level further minimizes the inconvenience of unsolicited email to the end user inasmuch as the end user is, in such an instance, unaware of the receipt of unsolicited email at the mail server which is directed to the end user.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A computer program product for minimizing the receipt of unsolicited email messages comprising:
a computer data storage device; and
computer program instructions, recorded on the computer data storage device, executable by a computer processor, for performing the steps of:
receiving an email message from a sender;
identifying the email message as comprising an unsolicited email message; and
generating at least one reply email message, wherein the reply email message comprises a “bounce back” email message, to, in turn, facilitate an identification of the email address to which the unsolicited email was sent as being an invalid email address.

2. The computer program product of claim 1 wherein the step of identifying comprises the step of requiring user identification of the email message as comprising an unsolicited email message.

3. The computer program product of claim 2 wherein the step of requiring further comprises the step of adding the sender to a database of senders of unsolicited email messages.

4. The computer program product of claim 3 wherein the step of requiring further comprises the step of requiring user identification only if the sender is not one of the senders of unsolicited email messages identified in the database of senders of unsolicited email messages.

5. The computer program product of claim 1 wherein the step of identifying comprises the steps of:
comparing the sender of the email message with a database of senders of unsolicited email; and
determining if the sender of the email message corresponds to one of the senders on the database of senders of unsolicited email.

6. The computer program product of claim 5 wherein the database used in the step of comparing is maintained at a second computing device.

7. The computer program product of claim 1 wherein the step of generating comprises the step of generating a plurality of “bounce back” email messages.

8. The computer program product of claim 1 wherein the computer program instruction comprises a plug-in to an email receiving software product.

9. A method for minimizing the receipt of unsolicited email messages comprising the steps of:
receiving an email message from a sender;
identifying the email message as comprising an unsolicited email message; and
generating at least one reply email message, wherein the reply email message comprises a “bounce back” email message, to, in turn, facilitate an identification of the email address to which the unsolicited email was sent as being an invalid email address.

10. The method of claim 1 wherein the step of identifying comprises the step of requiring user identification of the email message as comprising an unsolicited email message.

11. The method of claim 10 wherein the step of requiring further comprises the step of adding the sender to a database of senders of unsolicited email messages.

12. The method of claim 11 wherein the step of requiring further comprises the step of requiring user identification only if the sender is not one of the senders of unsolicited email messages identified in the database of senders of unsolicited email messages.

13. The method of claim 9 wherein the step of identifying comprises the steps of:
comparing the sender of the email message with a database of senders of unsolicited email; and
determining if the sender of the email message corresponds to one of the senders on the database of senders of unsolicited email.

14. The method of claim 13 wherein the database used in the step of comparing is maintained at a second computing device.

15. The method of claim 9 wherein the step of generating comprises the step of generating a plurality of “bounce back” email messages.
